(19) United States
(12) Patent Application Publication
(10) Pub. No.: US 2013/0173391 A1
(43) Pub. Date: Jul. 4, 2013

(54) LISTENING DEVICE

(71) Applicant: Arnaldo Zael Cruz, Miami, FL (US)

(72) Inventor: Arnaldo Zael Cruz, Miami, FL (US)

(21) Appl. No.: 13/540,584

(22) Filed: Jul. 2, 2012

Related U.S. Application Data
(60) Provisional application No. 61/504,078, filed on Jul. 1, 2011.

(51) Int. Cl. G06Q 30/02

(52) U.S. Cl. CPC G06Q 30/0267
USPC 705/14.64

(57) ABSTRACT

A listening device can be configured to receive an audio signal from a specific source. For example, the listening device may be configured to receive commentary at a sporting event or may be configured to receive audio from a television transmission. The listening device may be part of a system adapted to send the audio signal, and may also be configured to insert advertising into the audio stream where appropriate. For example, at a baseball game, the stadium may send an audio signal that with game stats, commentary and the like. Many fans may desire to receive such commentary and may, rent or buy a listening device specifically designed to receive the audio signal from the stadium. The stadium may then insert advertising in between innings, for example. This may permit the stadium to gain revenue through advertising, while also provide the fans with advertising that may be of interest.

### CROSS REFERENCE TO RELATED APPLICATIONS

This application claims the benefit of priority of U.S. provisional patent application No. 61/504,078, filed Jul. 1, 2011, the contents of which are herein incorporated by reference.

### BACKGROUND OF THE INVENTION

Often, at sporting events, for example, a fan may bring a portable radio to not only watch the game, but to hear commentary while watching. These fans may tune to a commercial radio station to receive this commentary. These fans also hear the advertisements of the commercial radio station during the game. Stadiums may have their own display screen to supply player stats as well as advertising, but, often, a fan with a radio may not pay much attention to these screens, since they are receiving their commentary over the radio while watching the game.

In restaurants and bars, one or more televisions may be displayed showing various channels. Speakers, with channel selection, may be provided to permit the users to listen to one of the variety of channels. The users hear the desired program along with the broadcasted advertisements. Should the restaurant or bar wish to advertise, they must do so around the televisions or in other areas.

As can be seen, there is a need for listening devices that may allow a local establishment the ability to transmit their own advertisements in addition to the aired content.

### SUMMARY OF THE INVENTION

In one aspect of the present invention, a system for delivering advertisements to a user at an establishment comprises a transmitter for sending audio content to a listening device; a receiver in the listening device for receiving the audio content, wherein the audio content includes one or more advertisements specifically directed to patrons at the establishment.

In another aspect of the present invention, a method for delivering advertising content to a user at an establishment comprises sending audio content to a listening device from a transmitter; receiving the audio content in the receiver; and placing one or more advertisements specifically directed to patrons at the establishment.

These and other features, aspects and advantages of the present invention will become better understood with reference to the following drawings, description and claims.

### BRIEF DESCRIPTION OF THE DRAWINGS

FIG. 1 is a schematic view of a listening system according to an exemplary embodiment of the present invention; and

FIG. 2 is a front view of a headphone embodiment of a listening device that can be used as a standalone unit or can be connected to a portable electronic device, such as a smart phone, according to an exemplary embodiment of the present invention.

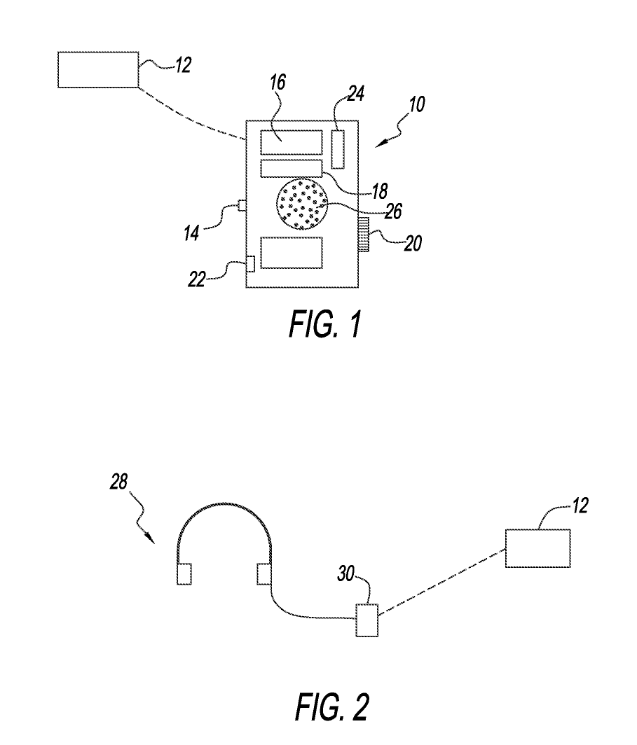

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an exemplary embodiment of the present invention provides a listening device that may be configured to receive an audio signal from a specific source. For example, the listening device may be configured to receive commentary at a sporting event or may be configured to receive audio from a television transmission. The listening device, however, may be part of a system adapted to send the audio signal, but may also be configured to insert advertising into the audio stream where appropriate. For example, at a baseball game, the stadium may send an audio signal that with game stats, commentary and the like. Many fans may desire to receive such commentary and may, for example, rent or buy a listening device specifically designed to receive the audio signal from the stadium. The stadium may then insert advertising in between innings, for example. This advertising may be focused to the specific area, stadium, and the like. This may permit the stadium to gain revenue through advertising, while also provide the fans with advertising that may be of interest, rather than national advertising that may appear on a commercial radio broadcast of the game.

Similarly, at a restaurant or bar, a patron may receive (buy, rent, or be given at their table) a listening device 10 that may permit the patron to tune to and listen to a specific signal sent from a transmitter 12 to a receiver 16 disposed in the listening device 10, such as a signal from one of the televisions being displayed in the establishment. The establishment may then, during the commercial breaks, provide their own advertisements to their patrons. These advertisements may be for the specific establishment, upcoming specials, or other items that may be of local interest.

In either embodiment, the establishment (restaurant, bar, stadium or the like) may provide an incentive to users to use the listening device. For example, during a ball game, a drink special may be communicated to all listening device users. Such incentives may not only increase sales at the stadium, but may also encourage users to listen to the advertisements, else they may miss specials that are announced.

The listening device 10 may include a delay setting so that the sound may be synchronized with the display. For example, a television in a restaurant may display a visual signal that may be a little ahead of the audio signal. The delay setting may be used to correlate the audio and visual signals.

The listening device 10 may include a language selector 14. The listening device may be adapted to receive a transmitted signal in various languages. For example, a sports show may be aired in English and Spanish via a second audio program (SAP). The listening device 10 may include a selector for choosing a primary or secondary language. Similarly, the advertisements may be recorded in a variety of languages. The listening device 10 may receive the advertisement in the selected language. The listening device 10 may be useful, for example, in a movie for receiving the movie audio in another language. This may save a movie-goer from reading subtitles so that they may focus on the movie itself. The listening 10 device may include a microphone (not shown) for recording speech and converting it into text for delivery to another device with a text/speech converter 18.

The listening device 10 may be part of a proprietary system. For example, a stadium may receive a license to transmit an audio signal at a particular frequency. The stadium may lend, rent or sell listening devices adapted to receive the proprietary system's frequency. In some embodiments, a listening device 10 may include a selector switch or dial 20 to choose to receive various frequencies. These listening devices 10 may be used, for example, to tune in various channels from a restaurant or bar, for example. In some embodiments, the transmitter 12 may be a satellite so that a listener at a Yankee baseball game, for example, may tune into and listen to a White Sox game from Chicago at the same time.

While the above embodiment describes listening devices for restaurant, bars, stadiums and the like, the device may be used in other environments. For example, exercise facilities often allow users to use listening devices that may receive a signal from a radio or one or more televisions. Such a facility may use the listening device to provide the desired content while inserting their own advertisements where appropriate.

In some embodiments, the listening device 10 may receive audio content, such as audio versions of newspapers, magazines, journals, books and other typically printed media. The listening device 10 may connect to the internet via a wired 22 or wireless adaptor 24 and may have its own internet protocol (IP) address for receiving content. For example, a newspaper may be downloaded daily and the user may have the ability to select which portions and/or articles of the newspaper to listen to through the listening device. The content may include advertisements specifically chosen by the publisher, content provider or the like. The advertisements maybe directed to various listening device users based on certain demographics.

The listening device 10 may be self-contained, such as with a speaker 26 containing box or employed as a set of headphones 28 (See FIG. 2). In some embodiments, the listening device 10 may be configured with a mobile device application, such as a smart phone app, to configure the listening device. For example, the listening device may be a conventional headphone, earbuds, or the like, when plugged into a smart phone 30 configured with an application that may permit the smart phone to receive the transmitted audio signal. In some embodiments, with certain smart phone apps, the data transmitted may contain both audio and visual data.

The listening device 10 may include a text to speech and a speech to text converter 18, offering the user the ability to receive digital text messages on their listening device and have these messages translated to speech. Similarly, the user may be able to record a message and have it converted into text. In some embodiments, the user may be allowed to send these text messages via, for example, SMS text messaging.

It should be understood, of course, that the foregoing relates to exemplary embodiments of the invention and that modifications may be made without departing from the spirit and scope of the invention as set forth in the following claims.

What is claimed is:

1. A system for delivering advertisements to a user at an establishment, comprising:
a transmitter for sending audio content to a listening device;
a receiver in the listening device for receiving the audio content, wherein
the audio content includes one or more advertisements specifically directed to patrons at the establishment.

2. The system of claim 1, further comprising a wireless adapter in the receiver for receiving audio content wirelessly.

3. The system of claim 1, further comprising a display screen in the receiver.

4. The system of claim 1, further comprising a wired adapted for connecting the receiver to the transmitter.

5. The system of claim 1, further comprising a language switch permitting the user to select one of a number of available languages for the audio content.

6. The system of claim 1, further comprising a speech to text converter so show a text version of the audio content.

7. The system of claim 1, where the receiver is a standalone, table-top unit.

8. The system of claim 1, wherein the receiver is a set of headphones.

9. The system of claim 8, wherein the headphones connect to a portable electronic device, where the portable electronic device has a software application adapted to act as a receiver to receive the audio content from the receiver.

10. A method for delivering advertising content to a user at an establishment comprising:
sending audio content to a listening device from a transmitter;
receiving the audio content in the receiver; and
placing one or more advertisements specifically directed to patrons at the establishment.

11. The method of claim 10, further comprising receiving the audio content wirelessly via a wireless adapter.

12. The method of claim 10, further displaying video content on a display screen in the receiver.

13. The method of claim 10, receiving the audio content via a wired connection.

14. The method of claim 10, further comprising changing an output language of the receiver by moving a language switch.

15. The method of claim 10, further comprising converting speech in the audio content to text and displaying the text on a display in the receiver.

15. The method of claim 10, where the receiver is a standalone, table-top unit.

16. The method of claim 10, wherein the receiver is a set of headphones.

17. The method of claim 16, further comprising using a portable electronic device as the receiver, where an application in the portable electronic device receives the audio content.

18. The method of claim 17, further comprising delivering the audio content from the portable electronic device to a set of headphones.

19. The method of claim 10, wherein the advertising content contains information about one or more specials or incentives at the establishment.
